(19) United States
(12) Patent Application Publication
(10) Pub. No.: US 2011/0063730 A1
(43) Pub. Date: Mar. 17, 2011

(54) DISK-SHAPED OPTICAL LENS ARRAY AND MANUFACTURING METHOD THEREOF

(76) Inventors: San-Woei SHYU, Taipei (TW); Huang-Chang Chen, Taipei (TW); Chih-Peng Wang, Taipei (TW); Te-Cheng Lin, Taipei (TW)

(21) Appl. No.: 12/880,833

(22) Filed: Sep. 13, 2010

(30) Foreign Application Priority Data
Sep. 11, 2009 (TW) 098130843

(51) Int. Cl. G02B 27/12; G02B 3/00; G02B 7/02; B29D 11/00

(52) U.S. Cl. 359/619; 359/642; 359/819; 264/2.2

(57) ABSTRACT

A disk-shaped optical lens array produced by resin injection-compression molding and a manufacturing method thereof are revealed. The disk-shaped optical lens array has at least one alignment fixture a first surface and a second optical surface. The optical surfaces respectively including a plurality of optical zones corresponding to each other so as to form a plurality of optical lens elements arranged in an array and a plurality of single optical elements is produced after cutting. At least one disk-shaped optical lens array and other optical lens element/or two disk-shaped optical lens arrays are aligned with an optical axis of an optical lens element by the alignment fixture to form a stacked disk-shaped optical lens array. Therefore the manufacturing processes of the optical lens arrays are simplified with improved precision and reduced cost.

### BACKGROUND OF THE INVENTION

The present invention relates to an optical lens array and a manufacturing method thereof, especially to a disk-shaped optical lens array and a manufacturing method thereof that are applied to lens assemblies of LED (light emitting diode) light sources, lens assemblies of solar energy systems, and lens modules of mobile cameras.

The resin injection-compression molding technology has been widely applied to various optical produces with high requirements of precision, size and optical properties such as DVD, CD-ROM, or optical lenses, as revealed in TW182060, and TWI309601. The resin injection-compression molding combines two techniques-injection molding and compression molding. A mold compression process is added into general injection molding processes. That means during the beginning of the resin casting process, the mold is not closed completely. The mold is closed by pressure after part of resin being filled into a mold cavity. The pressure is applied to melt resin material inside the mold cavity through the casting area. The processes are called “closing and clamping mold operations” and the mold cavity filling is finished by compression molding. Compared with injection molding, the residual stress is reduced, the difference in refractive index is decreased, and the optical lens element is with higher accuracy. As shown in US2008/0093756, JP2008-230005, JP2003-071874 etc., optical lens elements are produced by such molding method.

A conventional manufacturing process mainly produces a single optical lens element, especially resin injection molding. A plurality of mold cavities such as 4 or 8 cavities is arranged on a mold. 4 or 8 optical lens elements are injected at one time. After a runner stick being cut, a single optical lens is produced. As shown in FIG. 1, refer to U.S. Pat. No. 6,270,219, 10 optical lens elements 911 are produced by injection molding. In order to make each optical lens element 911 uniform, a down sprue for material input is disposed on a center of the mold cavity. The primary product includes a down sprue stick 9104 at the center thereof. After removing a runner stick 9103 on a periphery of each optical lens element 911, a single optical lens element 911 is formed.

In order to reduce production cost, many prior arts—JP2006-030722, JP2003-149409, JP2001-194508, TW M343166 etc. provide methods for manufacturing optical lens arrays. The produced optical lens array is applied to LED light sources or solar energy systems. Or the optical lens array is cut to form a plurality of single optical lens elements applied to lens modules of mobile cameras. Or the optical lens array is assembled with other optical components to form a lens sub-module array that is cut into a plurality of single lens sub-modules. The sub-module is assembled with lens holder, an image capture device other optical element to form a lens module. For different purposes or production processes, the optical lens array has different shapes. For example, arrays in a square arrangement are arranged on a square substrate, as shown in JP3182581, JP2003-004909, or arrays in a square arrangement are arranged on a round substrate, as shown in JP2001-129893, JP2001-042104. Or the optical lens arrays are produced by wafer level processes, as shown in U.S. Pat. No. 7,183,643, US2007/0070511, WO2008011003. Or refer to JP2001-042104, recesses with different depth are sued to prevent warpage and deformation of the micro lens array. Refer to JP2000-321526, two selfoc lenses are stacked by height and crevice to produce a selfoc array.

Refer to FIG. 2, an optical lens array is produced by injection-compression molding as shown in JP2007-030339 and JP2004-017555. Resin 952 is filled into a cavity formed by an upper mold and a lower mold 9511, 9512. Then apply pressure to the upper mold and the lower mold 9511, 9512 for pressurizing and compressing the resin 952. After curing, the upper mold and the lower mold 9511, 9512 are separated to remove an optical lens array 910. The pressure used in the injection-compression molding is lower than that of general injection molding so that residual stress in the optical lens array 910 is reduced. However, the optical lens array 910 is usually located on the edge of the primary product. When the resin is pressurized and moved to each optical lens element, the optical lens elements far away from the input point of the resin get lower pressure so that the optical lens elements are not uniform. Thus this method is not suitable for high precision optical lenses.

Each optical lens element of an optical lens array applied to optical systems is usually formed by non-spherical optical surfaces so that the optical lens element has more requirements on sag accuracy and alignment accuracy compared with ordinary optical lenses. Thus there is a need to provide a new design of the optical lens array that overcomes shortcomings of conventional optical lens arrays such as changes of sag accuracy and warpage caused by residual stress, and differences on edges caused by distances to the down sprue. Moreover, the manufacturing processes can be simplified and the cost is reduced. The optical lens array applied to lens assemblies of LED (light emitting diode) light sources, lens assemblies of solar energy systems, and lens modules of mobile cameras meets the requirements of mass production for a sufficient yield rate and amount.

### SUMMARY OF THE INVENTION

Therefore it is a primary object of the present invention to provide a disk-shaped optical lens array used in production of optical lens elements of optical systems and produced by resin injection-compression molding. A resin casting process is run through a center of a disk. The disk-shaped optical lens array is a round disk, having a disk hole at a center thereof, a first optical surface and a second optical surface. The first and the second optical surfaces respectively include a plurality of optical zones corresponding to each other so as to form a plurality of optical lens elements arranged in an array. The arrangement of the optical lens elements is not limited and can be arranged at equal intervals, in a radial arrangement, or in a sub-array. The type of the optical lens element is also not restricted. The optical lens element can be bi-concave lens, bi-convex lens, meniscus lens, M-shaped lens, Fresnel lens, etc according to users' needs. Or there are many different types optical lens elements arranged in the same disk-shaped optical lens array. The shape of the disk hole is not limited, and is able to be round, rectangular or polygonal according to users' requirements.

It is another object of the present invention to provide a disk-shaped optical lens array used in production of stacked optical lens elements of optical systems. The disk-shaped optical lens array includes at least one alignment fixture that aligns at least two disk-shaped optical lens arrays with optical axes of optical lens elements precisely so as to form a stacked disk-shaped optical lens array. Or a disk-shaped optical lens array and other optical element array are aligned with optical axes of optical lens elements precisely so as to form a stacked disk-shaped optical lens array. The structure of the alignment fixture is not limited. The alignment fixture can be an alignment pin and an alignment cavity, a collimator lens, a reticle or a through-hole. Moreover, a ring fixture that can be a protrusion ring, a groove ring or their combinations is arranged at a periphery of each optical lens element. The ring fixture is used for filling of glue or alignment. The optical element array can be another disk-shaped optical lens array, a spacer array, an aperture array, a cover glass, an IR-cut glass, an image capture device array, a photoelectric device array, or a printed circuit board (PCB).

It is a further object of the present invention to provide an optical lens element. By cutting along cutting lines of a disk-shaped optical lens array, the Therefore it is another object of the present invention to provide a disk-shaped optical lens array is singularized and cut to form a plurality of optical lens elements used in optical systems.

It is a further object of the present invention to provide a manufacturing method of a disk-shaped optical lens array which is based on a resin injection-compression molding method. A resin casting process is run through a center of a disk. The manufacturing method of the disk-shaped optical lens array includes the following steps:

S0: provide a resin injection-compression mold having an upper mold and a lower mold, respectively with an optical molding surface and a material inlet arranged at a center thereof;
S1: slightly open the upper mold and the lower mold to allow part of injected resin passing through the material inlet into a mold cavity, then apply pressure to the upper and the lower molds for mold closing and mold clamping; keep filling resin through the material inlet and complete the cavity filling with compression;
S2: separate the upper mold and the lower mold after cooling down to produce a primary product of a disk-shaped optical lens array;
S3: remove the primary product of the disk-shaped optical lens array that includes a disk-shaped optical lens array and a down sprue stick;
S4: cut off the down sprue stick to produce a disk-shaped optical lens array with a disk hole at the center thereof.

The manufacturing method further includes a S 5 step-set up cutting lines so as to cut the disk-shaped optical lens array along the cutting lines and produce a plurality of single optical lens elements or a plurality of single optical lens sub-arrays.

By the method, a precise disk-shaped optical lens array, a plurality of precise optical lens elements or a plurality of optical lens sub-arrays is produced at a time.

### BRIEF DESCRIPTION OF THE DRAWINGS

FIG. 1 is a schematic drawing showing optical lens elements produced by a conventional injection-compression molding method;

FIG. 2 is a schematic drawing showing manufacturing of conventional optical lens arrays;

FIG. 3 is a schematic drawing showing an embodiment of a disk-shaped optical lens array according to the present invention;

FIG. 4 is a schematic drawing showing an embodiment of a disk-shaped optical lens array being cut to produce a single optical lens element according to the present invention;

FIG. 5 is an embodiment of a disk-shaped optical lens array with alignment fixtures formed by alignment pins and grooves according to the present invention;

FIG. 6 is an embodiment of a disk-shaped optical lens array with collimator-type alignment fixtures according to the present invention;

FIG. 7 is an embodiment of a disk-shaped optical lens array with alignment fixtures formed by through holes and reticles according to the present invention;

FIG. 8 is another embodiment of a disk-shaped optical lens array according to the present invention;

FIG. 9 is a schematic drawing showing pressure distribution of filled resin of a conventional disk-shaped optical lens array;

FIG. 10 is a schematic drawing showing pressure distribution of filled resin of a disk-shaped optical lens array according to the present invention;

FIG. 11 is a schematic drawing showing a further embodiment of a disk-shaped optical lens array according to the present invention;

FIG. 12 is a schematic drawing showing a further (fourth) embodiment of a disk-shaped optical lens array according to the present invention;

FIG. 13 is a schematic drawing showing a further (fifth) embodiment of a disk-shaped optical lens array according to the present invention;

FIG. 14 is a schematic drawing showing a further (sixth) embodiment of a disk-shaped optical lens array according to the present invention;

FIG. 15 is a schematic drawing showing an optical lens sub-array of the embodiment in FIG. 14 according to the present invention;

FIG. 16 is another schematic drawing showing an optical lens sub-array of the embodiment in FIG. 14 according to the present invention;

FIG. 17 is a schematic drawing showing a further (seventh) embodiment of a disk-shaped optical lens array according to the present invention;

FIG. 18 is a schematic drawing showing an optical lens sub-array of the embodiment in FIG. 14 with alignment fixtures according to the present invention;

FIG. 19 is a schematic drawing showing a further (seventh) embodiment of a disk-shaped optical lens array according to the present invention;

FIG. 20 is a schematic drawing showing an injection-compression mold for producing a disk-shaped optical lens array according to the present invention;

FIG. 21 is a schematic drawing showing an injection-compression mold of the embodiment in FIG. 3;

FIG. 22 is a schematic drawing showing an injection-compression mold of the embodiment in FIG. 17;

FIG. 23 is a schematic drawing showing a flow char of manufacturing a disk-shaped lens array and optical lens elements;

FIG. 24 is a schematic drawing showing removing a down sprue stick of a primary product of a disk-shaped optical lens array according to the present invention.

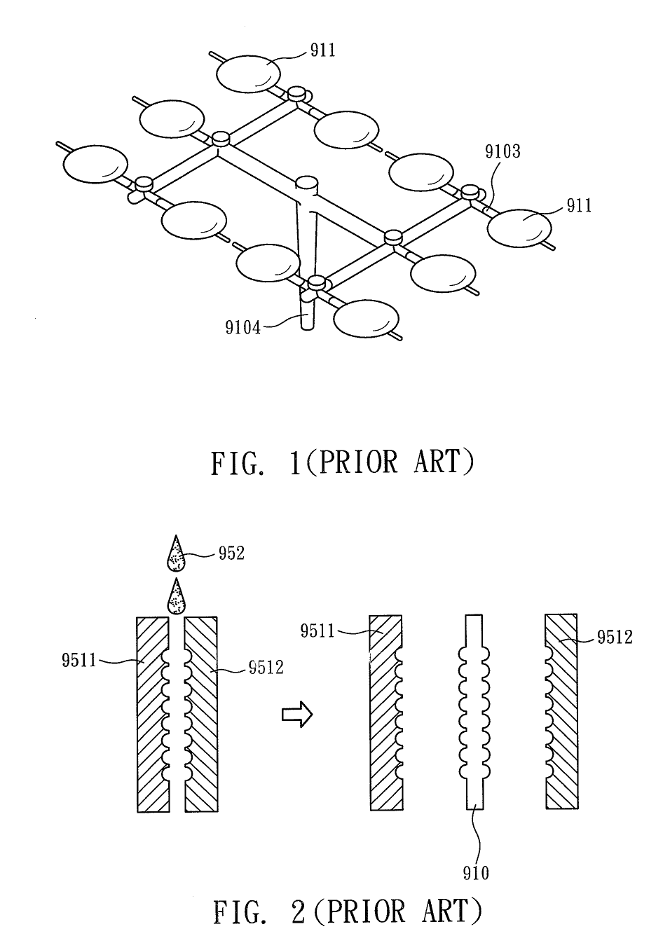

### DETAILED DESCRIPTION OF THE PREFERRED EMBODIMENT

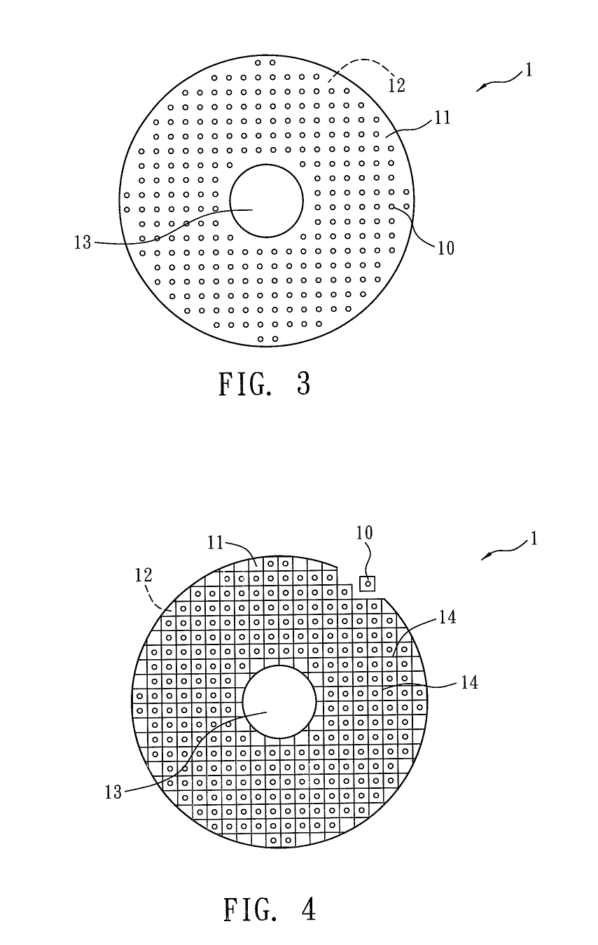

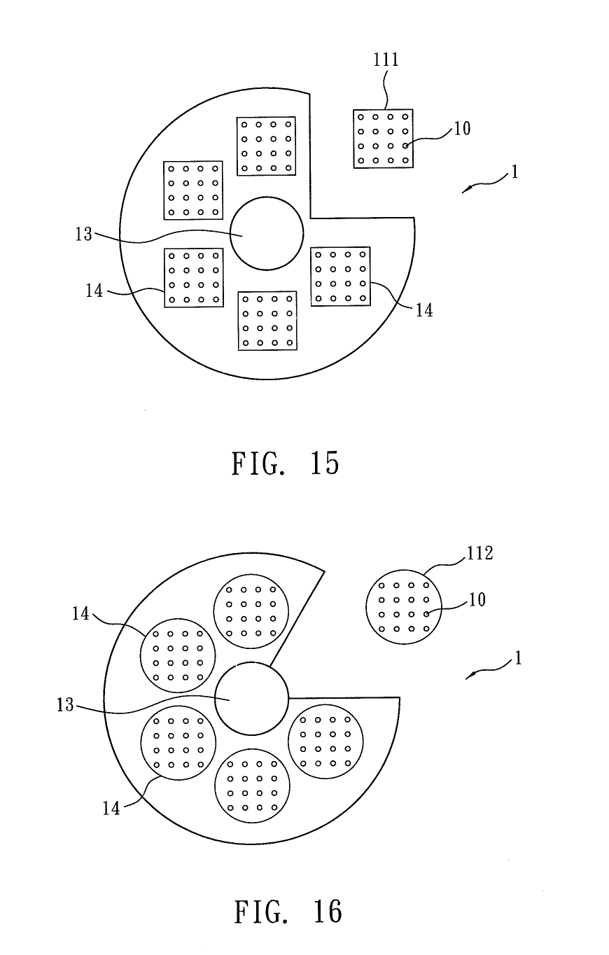

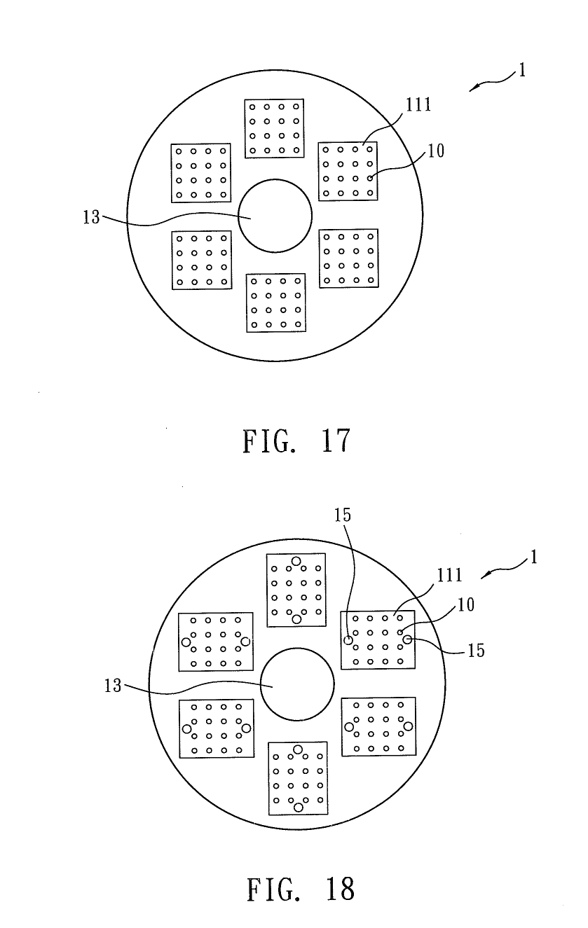

Refer to FIG. 3 and FIG. 4, a disk-shaped optical lens array 1 of the present invention is produced by resin injection-compression molding. A resin casting process is run through a center of a disk. The disk-shaped optical lens array 1 is a round disk, having a disk hole 13 at a center thereof, a first optical surface 11 and a second optical surface 12. The first and the second optical surfaces 11, 12 respectively include a plurality of optical zones corresponding to each other so as to form a plurality of optical lens elements 10 arranged in an array. Once the array is cut and divided along preset cutting lines 14, several single optical lens elements 10 are generated. Once the array is cut along a specific cutting line 14, a single optical lens array 111 is generated, as shown in FIG. 15 and FIG. 16.

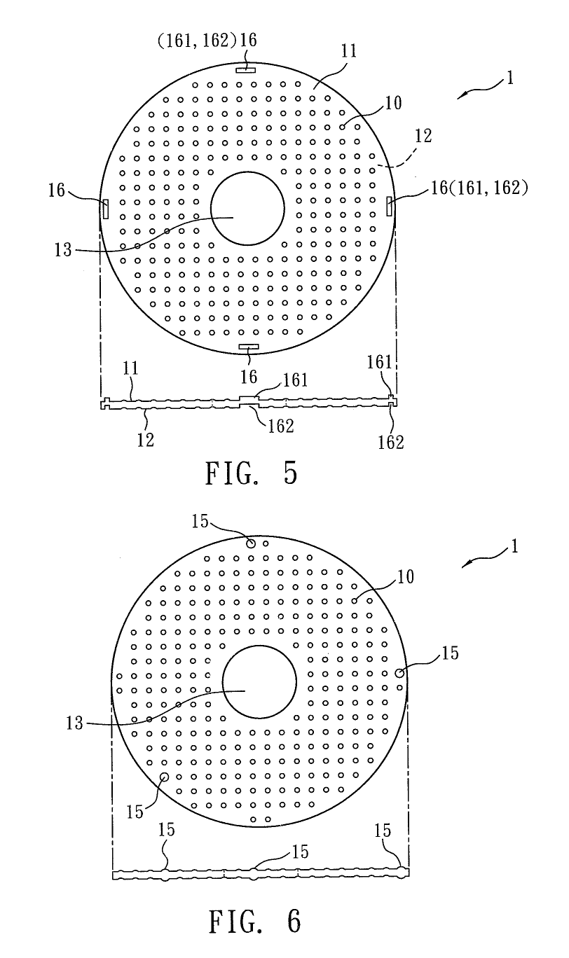

Refer from FIG. 5 to FIG. 7, the disk-shaped optical lens array 1 further includes an alignment fixture 15, 16 (17, 18). By the alignment fixture 15, 16 (17, 18), at least two disk-shaped optical lens arrays 1, 2 are aligned with an optical axis 101 of the optical lens element and are stacked to form a stacked disk-shaped optical lens array 100. Or as shown in FIG. 8, the disk-shaped optical lens arrays 1, 2 are aligned with the optical axis 101 of the optical lens element and are stacked to form a stacked disk-shaped optical lens array 100.

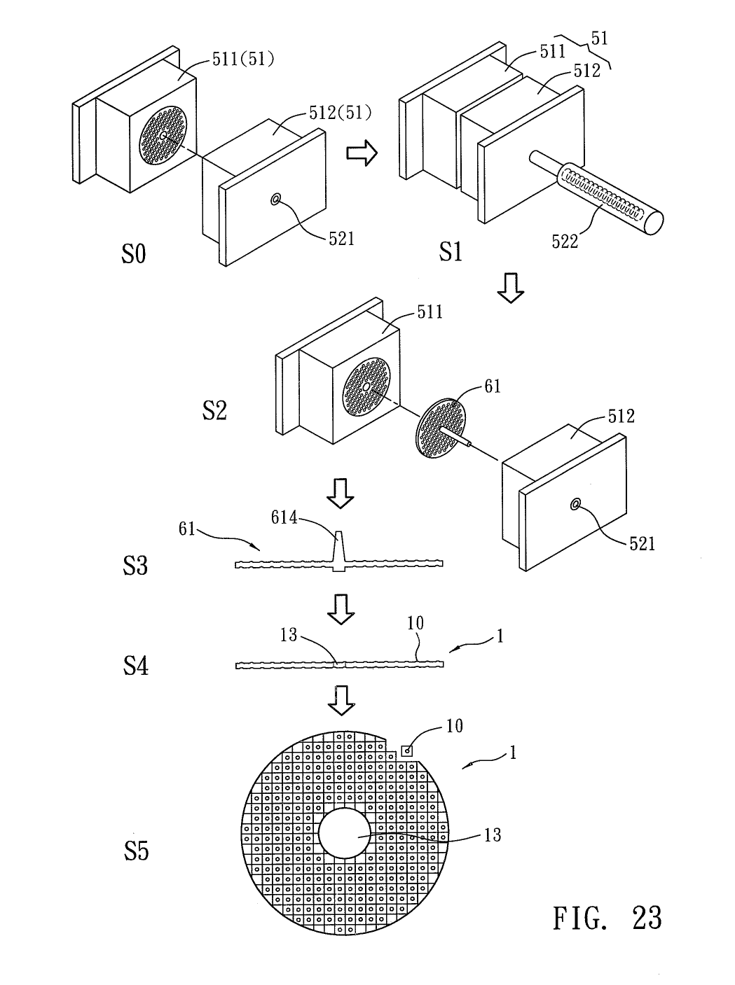

Refer to FIG. 23, a manufacturing method of a disk-shaped optical lens array 1 according to the present invention includes following steps:

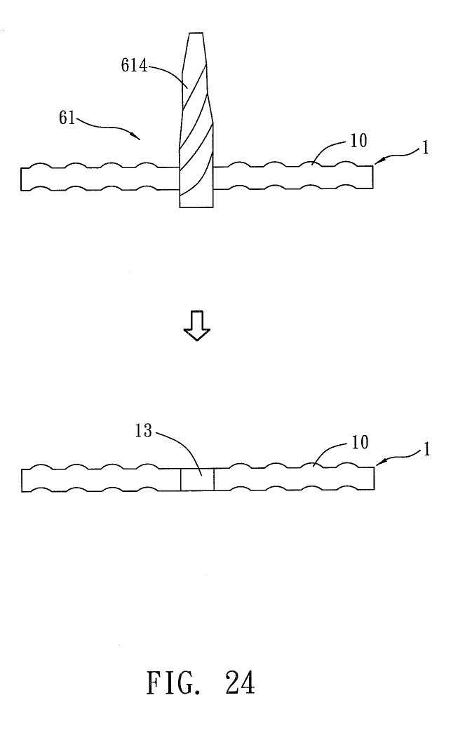

S0: provide an injection-compression mold 51 having an upper mold 511 and a lower mold 512 respectively with an optical molding surface while a material inlet 521 is arranged at a center of one optical molding surface of the upper mold and the lower mold;
S1: finish (complete) mold cavity filling by resin injection-compression molding;
S2: separate the upper mold 511 and the lower mold 512 after cooling down to produce a primary product of a disk-shaped optical lens array 61;
S3: remove the primary product of the disk-shaped optical lens array 61 that includes a down sprue stick 614 thereof;
S4: separate the down sprue stick 614 to produce a disk-shaped optical lens array 1 with a disk hole 13 at the center thereof, as shown in FIG. 24; according to users' needs, the disk hole 13 can be round, rectangular or polygonal;
S5: Set up cutting lines so as to cut the disk-shaped optical lens array 1 therealong and produce a plurality of single optical lens elements 10 or a plurality of single optical lens sub-arrays 111(112), as shown in FIG. 15 and FIG. 16.

### Embodiment 1

Refer to FIG. 3, FIG. 4 and FIG. 23, an embodiment of a disk-shaped optical lens array 1 includes a first optical surface 11 and a second optical surface 12, each having a plurality of (such as 212 but not limited to this number) corresponding optical zones to form 212 optical lens elements 10 arranged at equal intervals in an array. The disk-shaped optical lens array 1 is a round disk whose diameter is 120 mm and having a disk hole 13 at the center thereof. The disk hole 13 with a diameter of 30 mm is formed due to separation of a down sprue stick 614 from a primary product of a disk-shaped optical lens array 61, as shown in FIG. 24.

The disk-shaped optical lens array 1 is further disposed with cutting lines 14 which are arranged horizontally and vertically at equal intervals between two adjacent optical lens elements 10 by many ways such as drawing. Cutting the array 1 along the cutting lines 14, a plurality of single optical lens elements 10 such as 212 optical lens elements 10 is obtained at a time.

Refer to FIG. 23, a resin injection-compression molding machine used in this embodiment is similar to DVD production equipment. The resin material for the disk-shaped optical lens array 1 in this embodiment is optical polycarbonate (PC). The manufacturing method includes following steps:

S0: prepare a resin injection-compression mold 51 having an upper mold 511 and a lower mold 512, respectively arranged with a plurality of (such as 212) concave molding surfaces of aspherical surfaces correspondingly; the lower mold 512 includes a material inlet 521 at the center thereof;
S1: Open the upper and the lower molds 511, 512 slightly to allow part of injected resin (such as optical PC) passing through the material inlet 521 into a mold cavity, then apply pressure to the upper and the lower molds 511, 512 for mold closing and mold clamping and keep filling resin through the material inlet 521 and complete the cavity filling with compression. In this embodiment, the injection speed is 155 mm/sec, lower than common injection speed ranging from 250 to 300 mm/sec. The product obtained is with lower internal stress. During the process, the molding surfaces of the upper and the lower molds 511, 512 respectively are transferred onto the first optical surface 11 and the second optical surface 12 of the disk-shaped optical lens array 1.
S2: separate the upper and the lower molds 511, 512 after cooling down and obtain a primary product of a disk-shaped optical lens array 61;
S3: remove the primary product of the disk-shaped optical lens array 61 that includes the disk-shaped optical lens array 1 and a down sprue stick 614 thereof;
S4: cut off the down sprue stick 614 to get the disk-shaped optical lens array 1 having a plurality of (such as 212) bi-convex optical lens element 10 arranged at equal intervals in an array, as shown in FIG. 24; the disk-shaped optical lens array 1 includes a disk hole 13 at the center thereof and the disk hole 13 can be round, rectangular or polygonal according to users' requirements; in this embodiment, the disk hole 13 is round.
S5: Set up a plurality of (such as 21) vertical and horizontal cutting lines 14 on the disk-shaped optical lens array 1 and cut along the cutting lines 14 to produce a plurality of single optical lens elements 10. Thus 212 precise optical lens elements 10 are obtained at a time.

When the upper mold 511 and the lower mold 512 respectively are disposed with a plurality of (such as 212) concave and convex molding surfaces of aspherical surfaces, a disk-shaped optical lens array 1 including 212 meniscus optical lens elements 10 is obtained. When the upper mold 511 and the lower mold 512 respectively are arranged with a plurality of (such as 212) convex and convex molding surfaces of aspherical surfaces, a disk-shaped optical lens array 1 including 212 bi-concave optical lens elements 10 is produced. When the upper mold 511 and the lower mold 512 respectively are arranged with a plurality of (such as 212) M-shaped and M-shaped molding surfaces of aspherical surfaces, a disk-shaped optical lens array 1 including 212 M-shaped optical lens elements 10 is obtained. The so-called M-shaped optical lens element is an optical lens element that includes a inflection point of refractive power on a surface ranging from an optical center to edges of the optical lens element. The inflection point is the point at which the refractive power (curvature) changes from positive to negative or vice versa.

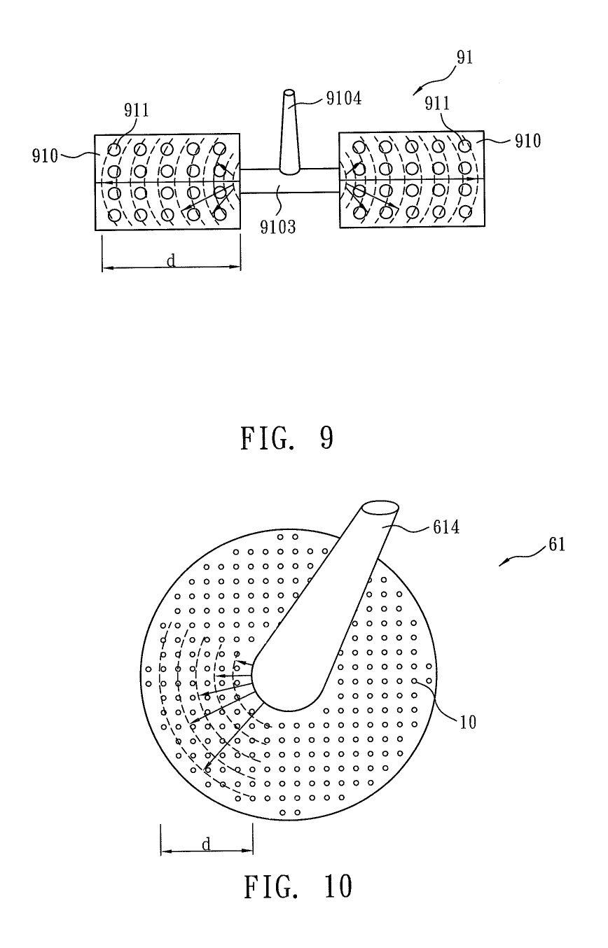

Refer to FIG. 9, a conventional primary product of a disk-shaped optical lens array 91 is revealed. The primary product of the disk-shaped optical lens array 91 includes two optical lens arrays 910 respectively having a plurality of optical lenses 911, a down sprue stick 9104 and a runner stick 9103. During the injection compression molding process, the injected resin material is filled into a middle part of the mold cavity (form the down sprue stick 9104), through the sprue (form the runner stick 9103). The resin material is moved from the center to the edge of the mold cavity in the form of a circle. The distance between the edge of the optical lens array 910 to the farthest optical lens 911 while the distances of different positions on the edge of the mold cavity are not the same. The resin is filled from one end of the optical lens array 910 so that the optical lenses 911 near the edge and near the end of filling resin get different pressures. Moreover, the resin injected into the mold cavity through the narrow sprue requires higher injection speed and higher speed tends to produce higher residual stresses. The residual stresses change at different positions. Therefore, it is difficult to produce the optical lens array 910 with small residual stress, less warpage and deformation or uniform distribution by the manufacturing method shown in FIG. 9.

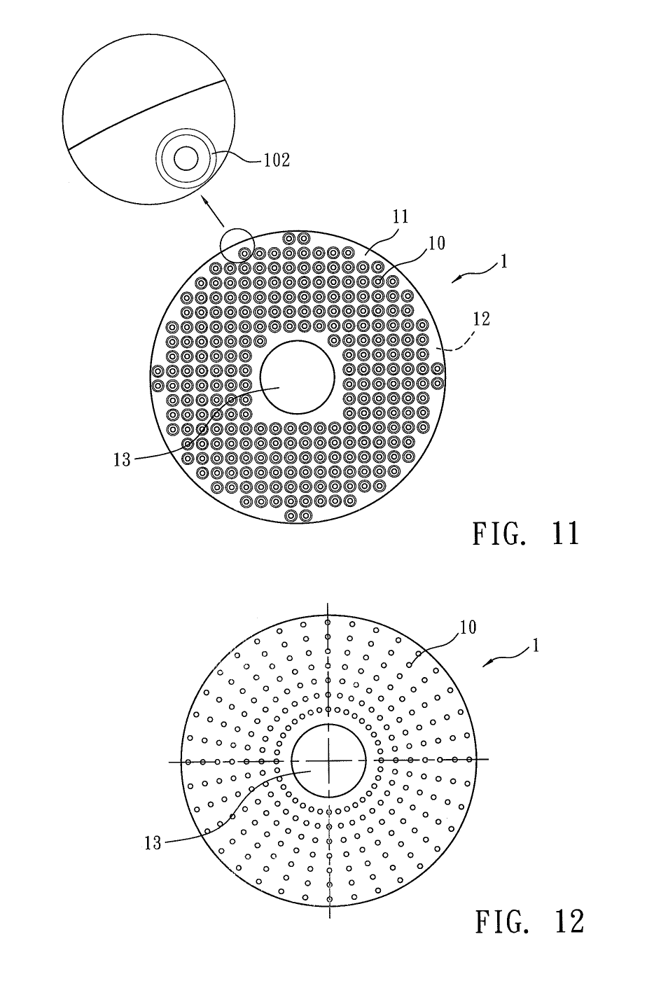

Refer to FIG. 10, a schematic drawing showing resin injection of the disk-shaped optical lens array 1 is disclosed. When the injected resin material is filled into the mold cavity (to form a down sprue stick 614 of a primary product 61) through a material inlet 521 of a lower mold 512, the resin material is pushed and moved toward the edge of the mold cavity in a circle. The material filling point is at the center of the array, the distance between the material filling point and the edge of the mold cavity is the same-distance d. The force acted on each optical lens element 10 is uniform. There is no problem raised similar to uneven pressure distribution around the edge shown in FIG. 9. Moreover, the injected resin enters into the mold cavity directly so that lower injection speed is used and the residual stress is reduced. Thus an optical lens array with higher precision and including uniform optical lens elements is obtained.

### Embodiment 2

Refer to FIG. 5, a first optical surface 11 and a second optical surface 12 of a disk-shaped optical lens array 1 in this embodiment respectively are disposed with corresponding 244 optical zones and four alignment fixtures 16. The 244 optical zones become into 244 optical lens elements 10 arranged at equal intervals in an array. The four alignment fixtures 16 are respectively arranged at the edge of the disk-shaped optical lens array 1. In this embodiment, the alignment fixtures 16 are four alignment protrusions 161 equally spaced around the first optical surface 11. The second optical surface 12 is arranged with four grooves 162 corresponding to the alignment protrusions 161.

The manufacturing method of the disk-shaped optical lens array 1 is the same with the embodiment one. Four concave cavities are disposed on the upper mold 511 while the lower mold 512 is arranged with four protrusions corresponding to the concave cavities. Thus the produced disk-shaped optical lens array 1 is an array includes 244 optical lens elements 10 and four sets of alignment fixtures 16.

By the same manufacturing method, the upper mold 511 and the lower mold 512 are respectively arranged with different molding alignment surfaces so as to produce a disk-shaped optical lens array 1 with various alignment fixtures. As shown in FIG. 6, the upper mold 511 is arranged with three spherical cavities and 244 molding surfaces of aspherical surfaces while the lower mold 512 is disposed with three spherical cavities and 244 molding surfaces of aspherical surfaces so as to produce a disk-shaped optical lens array 1 including 244 optical lens elements 10 and three collimator-type alignment fixtures 15. The collimator-type alignment fixture 15 is a bi-convex spherical lens. An optical calibration instrument is used and a laser beam passes the alignment fixture 15 for alignment. The alignment precision is 5 μm or less, used for precision assembly.

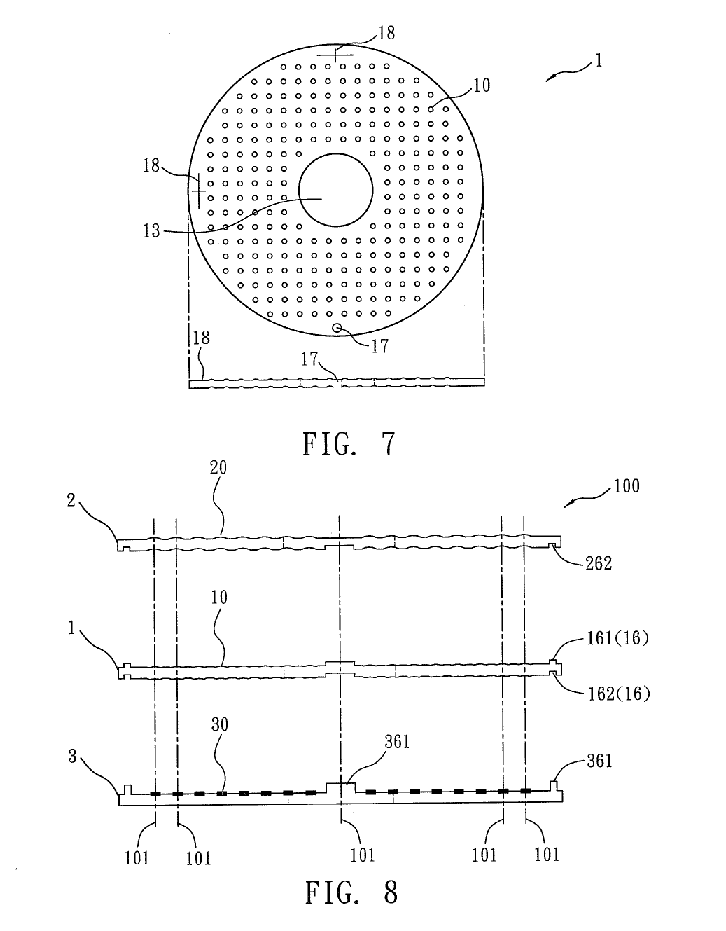

For precision alignment, the upper mold 511 or the lower mold 512 is arranged with reticle alignment fixture 18. The reticle is located on a set-point of the molding surface of the aspherical surface. The reticle alignment fixture 18 of a disk-shaped optical lens array 1 produced by this mold is as shown in FIG. 7. While assembling, the alignment is performed by the alignment fixture 18. The alignment precision is 3˜5 μm or less, used for precision assembly.

Still FIG. 7, the upper mold 511 is set with three protrusion points and 244 aspherical surfaces while the lower mold 512 is disposed with three protrusion points and 244 aspherical surfaces. Thus a disk-shaped optical lens array 1 formed by 244 optical lens elements 10 and three through-hole type alignment fixtures 17 (only one alignment fixtures 17 shown in FIG. 7) is produced and the alignment fixtures 17 is used for following assembling processes.

Refer to FIG. 8, a stacked disk-shaped optical lens array 100 includes two disk-shaped optical lens arrays 1, 2 and an optical element array 3. The disk-shaped optical lens array 1 includes four alignment fixtures 16 and 244 M-shaped optical lens elements 10. The alignment fixtures 16 are formed by four (4) alignment pins 161 and 4 four grooves 162. The disk-shaped optical lens array 2 includes four grooves 262 for alignment and 244 meniscus lenses 20 arranged in an array. As to the optical element array 3, it includes 244 image capture devices 30 and four alignment pins 361 corresponding to the 4 alignment pins 161, the 4 four grooves 162 of the disk-shaped optical lens array 1, and four grooves 262 for alignment and 244 of the disk-shaped optical lens array 2. While assembling, by the alignment pins 361 and alignment pins 161 corresponding to and assembling with grooves 162 and grooves 262, each optical lens elements 20, 10 of the disk-shaped optical lens arrays 2, 1 and each image capture device 30 of the optical element array 3 are aligned with one another along each optical axis 101. The non-optical zone of each optical lens element is glued (not shown on figure). After assembling and curing, the stacked disk-shaped optical lens array 100 is obtained.

### Embodiment 3

Refer to FIG. 11, this embodiment is a disk-shaped optical lens array 1 with a ring fixture. Each optical lens element 10 is disposed with a ring fixture 102. When the disk-shaped optical lens array 1 is cut into a plurality of single optical lens elements 10, the ring fixture 102 is used as a groove for glue or an alignment fixture. In this embodiment, the disk-shaped optical lens array 1 includes a first optical surface 11, a second optical surface 12 and a plurality of optical lens elements 10 arranged at equal intervals in an array. At least one optical lens element 10 is arranged with a ring fixture 102 at a peripheral thereof. The ring fixture 102 is a circular groove. Adhesive is coated on the groove formed by the ring fixture 102 so as to assemble with other optical elements to produce optical lenses while the disk-shaped optical lens array 1 being cut into single optical lens elements 10, as shown in FIG. 4. The ring fixture 102 can be a convex circle or a concave circle whose center is on the optical axis. Thus the ring fixture 102 is aligned with the optical axis so as to produce high precision optical lens modules while being assembled with other optical elements.

### Embodiment 4

Refer to FIG. 12, this embodiment is a radial arranged disk-shaped optical lens array 1. A plurality of optical lens elements 10 is arranged from a center of the disk-shaped optical lens array 1 to a circumference thereof in a radial arrangement. The disk-shaped optical lens array 1 of this embodiment is used as an optical lens array together with a wafer disc having dies. The disk-shaped optical lens array 1 is assembled with a wafer disc and the position of each die corresponds to each optical lens element 10. This embodiment is applied to a light emitting diode (LED) array. Each LED die is disposed on a wafer disc in a radial arrangement while the plurality of optical lens elements 10 of the disk-shaped optical lens array 1 is also in a radial arrangement. When the wafer disc and the disk-shaped optical lens array 1 are assembled with each other, each optical lens element 10 and each LED die are aligned with each other so that light emitted from each LED die is focused by each optical lens element 10 and is projected outwards. By such way, a LED array is produced at a time so as to achieve precise assembly and reduced cost.

### Embodiment 5

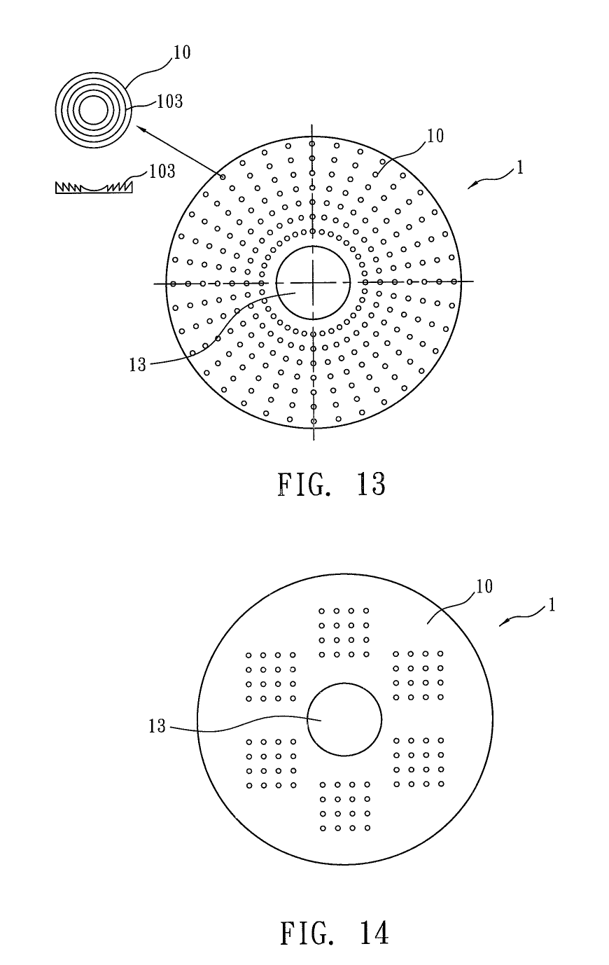

Refer to FIG. 13, this embodiment is a disk-shaped optical lens array 1 with a Frensel optical surface. The disk-shaped optical lens array 1 of this embodiment is used as an optical lens array, assembled with a wafer disc and the position of each die corresponds to each optical lens element 10. In this embodiment, the disk-shaped optical lens array 1 is applied to a solar energy system in which each photovoltaic die is disposed on a wafer disc in a radial arrangement. After the wafer disc and the disk-shaped optical lens array 1 assembled with each other, each solar dies and each optical lens element 10 are aligned correspondingly so that incident solar beam is focus by each optical lens element 10 and is projected onto each solar die. By such assembling, a solar energy device array is produced at a time so as to achieve precise assembly and reduced cost.

### Embodiment 6

Refer to FIG. 14, FIG. 15, FIG. 16, optical lens elements 10 on a disk-shaped optical lens array 1 of this embodiment is arranged in a sub-array way. A plurality of optical lens elements 10 forms a sub-array and a plurality of sub-arrays is arranged on the disk-shaped optical lens array 1. As shown in FIG. 14, a rectangular sub-array consists of 16 (4×4) optical lens elements 10 and the disk-shaped optical lens array 1 includes 6 sub-arrays. As shown in FIG. 15 and FIG. 16, cutting lines 14 are drawn on the disk-shaped optical lens array 1. Then cut the disk-shaped optical lens array 1 along the cutting lines to produce a single optical lens sub-array 111. Refer to FIG. 15, 6 rectangular optical lens sub-arrays 111 are cut and produced. Or as shown in FIG. 16, 6 round optical lens sub-arrays 112 are cut and produced. Each optical lens sub-array 111/112 having 16 (4×4) optical lens elements 10 is applied to an optical system.

The manufacturing method and the related steps of this embodiment are similar to those of the embodiment one (shown in FIG. 23). The difference in that the upper and the lower molds 511, 512 of the resin injection-compression molding 51 are respectively disposed with 96 corresponding molding surfaces of aspherical surfaces so as to produce 96 optical lens elements 10 that is arranged in a 4×4 array.

### Embodiment 7

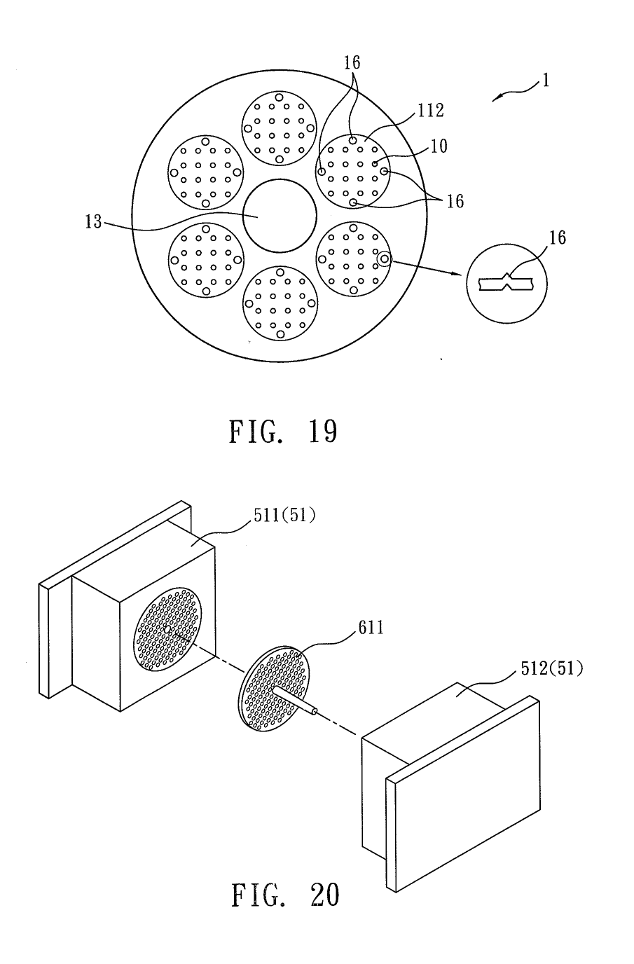

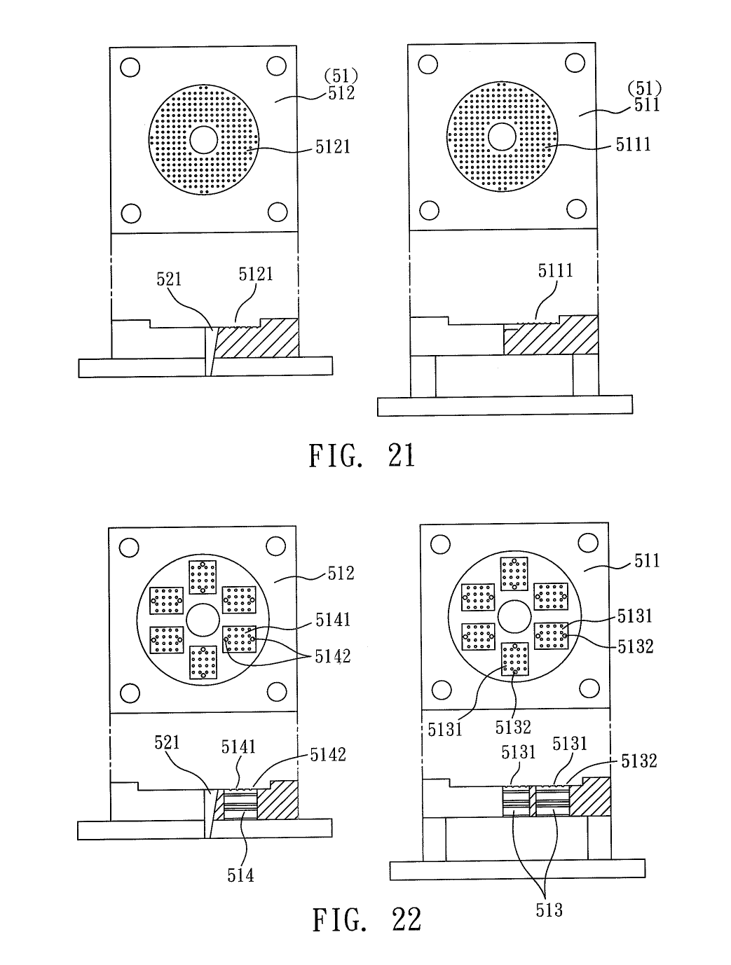

Refer to FIG. 17, FIG. 18, and FIG. 19, optical lens elements 10 on a disk-shaped optical lens array 1 of this embodiment is arranged in a sub-array way, as the embodiment 6 and each sub array includes alignment fixtures, As shown in FIG. 17, there are 6 rectangular sub-arrays 111 and each optical lens sub-array 111 having 16 (4×4) optical lens elements 10. Moreover, each optical lens sub-array 111 further includes alignment fixtures 15 (16). Refer to FIG. 18, each optical lens sub-array 111 is disposed with two collimator type alignment fixtures 15. While assembling, optical calibration systems align the optical axes by the alignment fixtures 15 so as to produce high precision optical systems. Or as shown in FIG. 19, each optical lens sub-array 111 is set with four alignment fixtures 16 formed by V-shaped alignment pins and V-shaped grooves. The optical lens sub-array 111 is aligned and assembled with other optical elements by the alignment fixtures 16 during assembling processes.

The resin injection-compression mold 51 of the disk-shaped optical lens array 1 is in a modularized structure. Refer to FIG. 22, the resin injection-compression mold 51 consists of an upper mold 511 and a lower mold 512. The upper mold 511 is disposed with 6 upper mold cores 513 and each upper mold core 513 includes an upper molding surface 5131 for producing optical surface of the optical lens sub-array 111 and an upper molding alignment surface 5132 for producing the alignment fixture 15 (or other alignment fixture 16). The lower mold 512 is arranged with 6 lower mold cores 514 and each lower mold cone 514 includes a lower molding surface 5141 for producing optical surface of the optical lens sub-array 111 and a lower molding alignment surface 5142 for producing the alignment fixture 15 (or other alignment fixture 16). Furthermore, the upper mold core 513 and the lower mold core 514 are designed with replaceable structure. Thus the upper and the lower mold cones 513, 514 can be replaced according to different optical surfaces or alignment fixtures required and a modularized resin injection-compression mold.

What is claimed is:

1. A disk-shaped optical lens array produced by resin injection-compression molding and resin casting process through a center of a disk comprising a round disk with a disk hole at a center thereof, a first optical surface having a plurality of optical zones and non-optical zones and a second optical surface having a plurality of optical zones and non-optical zones corresponding to the optical zones and the non-optical zones of the first optical surface; wherein the optical zones and the corresponding optical zones form a plurality of optical lens elements and the plurality of optical lens elements is arranged in an array.

2. The device as claimed in claim 1, wherein the optical lens elements are bi-concave lenses, bi-convex lenses, meniscus lenses, M-shaped lenses, Fresnel lenses or their combinations.

3. The device as claimed in claim 1, wherein the optical lens elements are in equal-interval arrangement, in a radial arrangement, or sub-array arrangement; the sub-array arrangement includes a plurality of sub-arrays each of which is formed by a plurality of optical lens elements and the plurality of sub-arrays are disposed on the disk-shaped optical lens array.

4. The device as claimed in claim 1, wherein the disk hole is round, rectangular or polygonal.

5. The device as claimed in claim 1, wherein a ring fixture is arranged at a periphery of the optical lens element and the ring fixture is a protrusion ring, a groove ring or their combinations.

6. The device as claimed in claim 1, wherein the non-optical zone is disposed with at least one alignment member for aligning the disk-shaped optical lens array with an optical axis of the optical lens element and being stacked with each other.

7. The device as claimed in claim 6, wherein the alignment fixture is an alignment pin, a groove, a collimator lens, a through-hole, a reticle or their combinations.

8. An optical lens sub-array produced by cutting and dividing a disk-shaped optical lens array as claimed in claim 1, wherein the optical lens sub-array includes a plurality of optical lens elements arranged in an array.

9. The optical lens sub-array as claimed in claim 8, wherein the optical lens sub-array further includes at least one alignment fixture and the alignment fixture is an alignment pin, a groove, a collimator lens, a through-hole, a reticle or their combinations.

10. An optical lens element is produced by cutting and dividing a disk-shaped optical lens array as claimed in claim 1 into a plurality of single optical lens elements.

11. The optical lens element as claimed in claim 10, wherein a ring fixture is arranged at a periphery of the optical lens element and the ring fixture is a protrusion ring, a groove ring or their combinations.

12. A manufacturing method of a disk-shaped optical lens array that produce the disk-shaped optical lens array by resin injection-compression molding comprising the steps of:
S0: providing a resin injection-compression mold having an upper mold and a lower mold while the upper mold and the lower mold respectively have an optical molding surface and a material inlet arranged at a center thereof;
S1: opening the upper mold and the lower mold slightly to allow part of injected resin passing through the material inlet into a mold cavity formed by the upper mold and the lower mold, then applying pressure to the upper mold and the lower mold for mold closing and mold clamping; keeping filling resin through the material inlet and completing the cavity filling with compression;
S2: separating the upper mold and the lower mold after cooling down to produce a primary product of a disk-shaped optical lens array;
S3: removing the primary product of the disk-shaped optical lens array that includes a down sprue stick thereof; and
S4: cutting off the down sprue stick to produce a disk-shaped optical lens array with a disk hole at the center thereof.

13. The manufacturing method as claimed in claim 12, wherein the manufacturing method further includes a step of:
S5: setting up cutting lines so as to cut the disk-shaped optical lens array along the cutting lines and produce a plurality of single optical lens elements.

14. The manufacturing method as claimed in claim 12, wherein the manufacturing method further includes a step of:
S5′: setting up cutting lines so as to cut the disk-shaped optical lens array along the cutting lines and produce a plurality of single optical lens sub-arrays.
